(19) United States
(12) Patent Application Publication
(10) Pub. No.: US 2021/0158018 A1
(43) Pub. Date: May 27, 2021

(54) ANIMATED APPARATUS FOR VEHICLES

(71) Applicant: Turbo Style Products, LLC, Park City, UT (US)

(72) Inventor: Robert A. Small, Park City, UT (US)

(21) Appl. No.: 17/098,800

(22) Filed: Nov. 16, 2020

Related U.S. Application Data
(60) Provisional application No. 62/936,219, filed on Nov. 15, 2019.

(51) Int. Cl. G06K 9/00; B60W 20/13; G06F 1/16

(52) U.S. Cl. CPC G06K 9/00221; G06F 1/16; B60W 20/13; G06K 9/00845

(57) ABSTRACT

An animated apparatus for vehicles can comprise an animated apparatus, an actuator, a controller, and a power supply. The animated apparatus having a shape to mimic an anatomical structure. The actuator coupled to the animated apparatus and capable of moving the animated apparatus mounted on the vehicle to mimic a gesture or movement of a portion of a creature or human anatomical structure or body part. The controller in electronic or mechanical communication with the actuator, wherein the controller responds to an input so as to control via the actuator a movement of the animated apparatus. The power supply coupled to the actuator to supply power to the actuator; and a vehicle coupling mechanism operable to couple at least one of the animated device and the actuator to a vehicle.

### RELATED APPLICATION(S)

This application claims priority to U.S. Provisional Application No. 62/936,219, filed Nov. 15, 2019 which is incorporated herein by reference.

### BACKGROUND

Humans have long projected living qualities onto inanimate objects. From seeing creatures and beings in the shapes and forms of trees and rocks to creating sculptural representations of creatures real and imagined. These projections are referred to as personification and anthropomorphism.

Similarly, people have often ascribed personalities to their vehicles, decorating them and even giving them names. There is a thriving industry for modifying vehicles to suit an owner's personality. From custom decals to aftermarket accessories, owners can customize their vehicles to match the personality ascribed to the vehicle.

When a person or creature makes facial expressions, they are transmitting information that can be received, read and interpreted by others. By contracting or expanding our facial muscles in different degrees and combinations, we can produce thousands of different messages that provide cues to our overall emotional state, our short-term feelings, our personality and mood. These facial expression do not readily transfer to vehicles, since a vehicle does not have a face to manipulate to deliver any messages. Additionally, accessories are typically fixed to a vehicle such that they are not movable and therefore any expression is fixed.

### SUMMARY

A purpose of this invention is to allow the attachment of various kinds of animated apparatus to vehicles in order to create a sense the vehicle is actually alive and can demonstrate a personality and other qualities of living creatures. The expression can be dynamic such that the expression and the information expressed can be changed depending on the personality the owner desires to project through the vehicle.

Embodiments of an animated apparatus are described herein. In one embodiment, the animated apparatus is shaped like an eyelash and is attached above a vehicles headlights so as to create the impression that the headlights are eyes and the apparatus when animated makes the eyes appear to blink or wink.

Other embodiments of the animated apparatus are shaped like eyebrows, lips, facial muscles, or any portion of a creature or human anatomical structure or body part.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1a illustrates an example of an animated apparatus with eyelashes.

FIG. 1b illustrates an example of the animated apparatus of FIG. 1a.

FIG. 1c illustrates an example of the eyelashes of FIG. 1a with the eyelashes in various positions.

FIG. 1d illustrates an example of the components of the animated apparatus of FIG. 1a.

FIG. 2a illustrates an example of an animated apparatus with eyebrows.

FIG. 2b illustrates an example of the animated apparatus of FIG. 2a.

FIG. 2c illustrates an example of the eyebrows of FIG. 2a as displayed on a vehicle.

FIG. 2d illustrates an example of the components of the animated apparatus of FIG. 2a.

FIG. 3a illustrates an example of an animated apparatus with lips.

FIG. 3b illustrates an example of the animated apparatus of FIG. 3a.

FIG. 3c illustrates an example of the lips of FIG. 3a as displayed on a vehicle.

FIG. 3d illustrates an example of the components of the animated apparatus of FIG. 3a.

FIG. 4a illustrates an example of an animated apparatus with pupils.

FIG. 4b illustrates an example of the animated apparatus of FIG. 4a.

FIG. 4c illustrates an example of the eyes of FIG. 4a with the pupils in various positions.

FIG. 4d illustrates an example of the pupils of the animated apparatus of FIG. 4a.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

Definitions

In describing and claiming the present invention, the following terminology will be used.

The singular forms “a,” “an,” and “the” include plural referents unless the context clearly dictates otherwise. Thus, for example, reference to “a motor” includes reference to one or more of such features and reference to “subjecting” refers to one or more such steps.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, and combinations of each.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

Animated Apparatus

An animated apparatus for vehicles is an apparatus that mimics the shape of any anatomical structure of a living creature and that can be animated. The animated movement of the animated apparatus, combined with the shape and location of animated apparatus on the vehicle creates the perception that the vehicle is a living creature with personality and the animated apparatus is a part of this creature that can express personality.

The apparatus is coupled to an actuator capable of moving the apparatus so that the apparatus mimics the movement of a body part—for example an eye winking or an eyebrow raising. If the body part represented is part of a face the movement can mimic an emotional expression such as surprise or anger. If the body part represented is another part of a creature's body it can still mimic the posture or attitude of the creature—for example puffing up feathers, or ears laying back (as seen when a dog growls or a cat hisses).

The animation of the apparatus is managed by a controller in electronic or mechanical communication with the actuator. The controller responds to an input and sends signals to the actuator which animates the apparatus. The input to the controller can be the manipulation of buttons, dials, keys, knobs, levers, push buttons, selectors, or switches by an operator either onboard or not onboard the vehicle. In one configuration, a hand held or dash mounted box incorporating these elements can control the animated apparatus.

In another configuration, an operator's arms, hands, and finger movements can be sampled through sensors attached to the operator and provide input to directly control the movement of corresponding animated apparatus attached to the vehicle that are for example, configured to look and move like a creature's arms, hands, and fingers.

The input to the controller does not need to come from a living person, a computer program running on a microprocessor could provide input to the controller. The program could receive sensor input to determine which signals to send to the controller based on the desired animation. For example, a sensor could detect a person near the vehicle and direct the apparatus, configured to look like the pupils of an eye, to look at and follow the person as they walked by. The proximity of a person or another vehicle could initiate the program to direct the apparatus configured to look like an eyelash to wink. A sensor could detect vehicle movement and direct the pupils to look in the direction the vehicle is moving or animate eyebrows to look angry when the vehicle is accelerating.

The computer program could use sensors to watch an operator's facial expressions and head movement. In one configuration, the sensor could be a video camera that provides information to track the facial expressions of the operator and translate them into corresponding animation of the apparatus. This would allow the operator to quickly translate their own emotional facial expressions directly to the apparatus and show corresponding emotion on the vehicle—for example, smiling, surprise, and anger.

The operator inputs control the animation of the apparatus to be consistent with the desired behavior of the creature including interacting with and/or responding to other vehicles, people, creatures, and other elements in the environment.

The actuator is connected to a power supply which would most likely be electric, pneumatic, hydraulic, or mechanical.

At least one actuator and apparatus are connected to the vehicle via a coupling mechanism. The coupling mechanism can be intended to keep the apparatus attached to the vehicle for the life of the vehicle, or removable. If the apparatus is intended to be removable, the coupling device can incorporate fasteners between the vehicle and the apparatus that can snap, clip, screw, bond via double sided tape, glue, or otherwise removably adhere to a surface of the vehicle.

The types of vehicles that the animated apparatus can be attached to include, but are not limited to: car, truck, bus, golf cart, tractor, motorcycle, motor bike, bicycle, scooter, skateboard, hover board, surf board, snow board, train, plane, glider, parachute, drone, boat, ship, watercraft, all terrain vehicle, snowmobile, and jet ski.

The types of anatomical structure that can be represented include but are not limited to: eyelashes, eyelids, eyeballs, eyebrows, lips, mouth, cheek, nose, face, tongue, arms, legs, hands, and fingers. The various anatomical structures would generally be placed on the vehicle in locations that enhance the impression that the vehicle is a living creature. For example, Eyebrows would be placed above a vehicles headlights so the headlights appeared to be eyes. Eyelashes would be placed so that they rotated forward and down in front of the headlight when animated, creating the impression that the headlights are eyes.

Generally, the types of actuators coupled to the animated apparatus would be rotary and linear servo motors, and rotary and linear hydraulic or pneumatic pistons. Rotary actuators work well for limb joints and eye opening and closing movement. Linear actuators work well for raising eyebrows and opening mouth and lip shapes. Combinations of linear and rotary actuators can allow complex movements of the apparatus such as rotating the eyes while blinking and facial shaping of forehead, cheeks, jaws, and the shaping of lips into a kiss or broad and narrow smiles.

Adding large eyelashes above headlights on a vehicle makes the headlights appear to be the eyes of the vehicle. When the eyes wink and blink the vehicle seems to be alive. The vehicle can wink at pedestrians in a crosswalk or viewers at a parade.

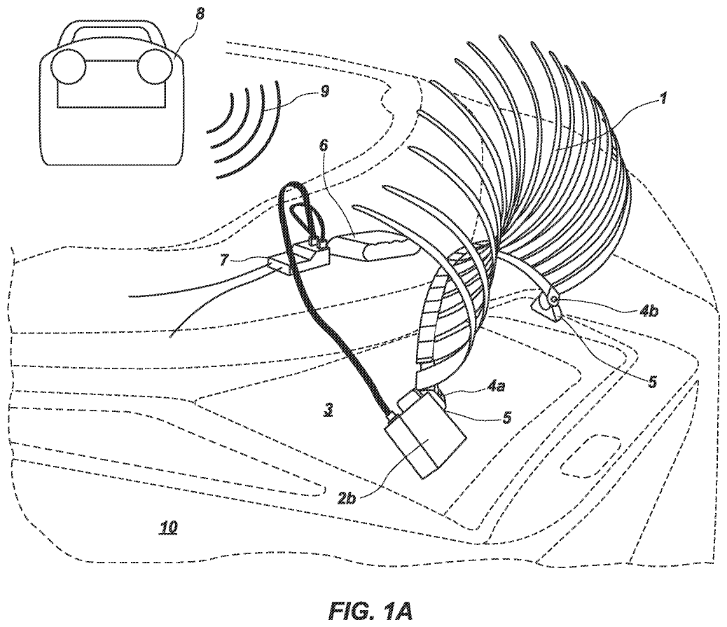

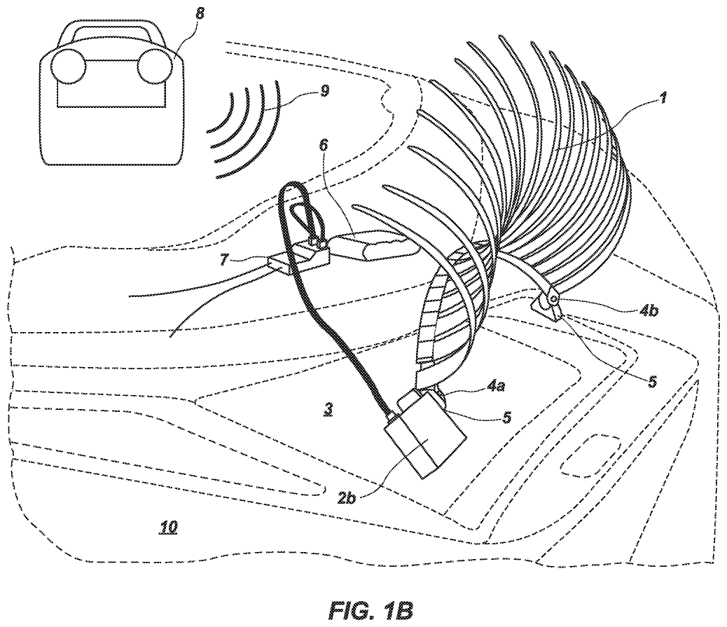

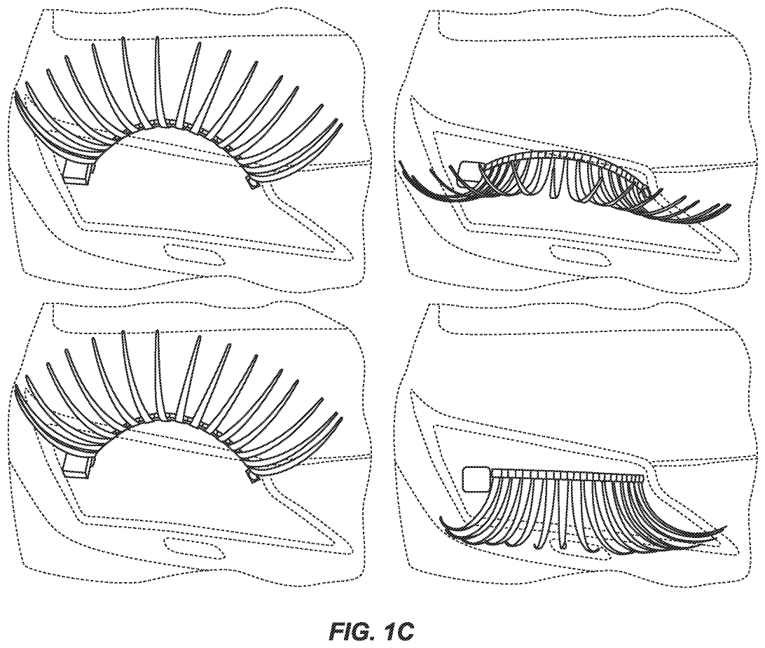

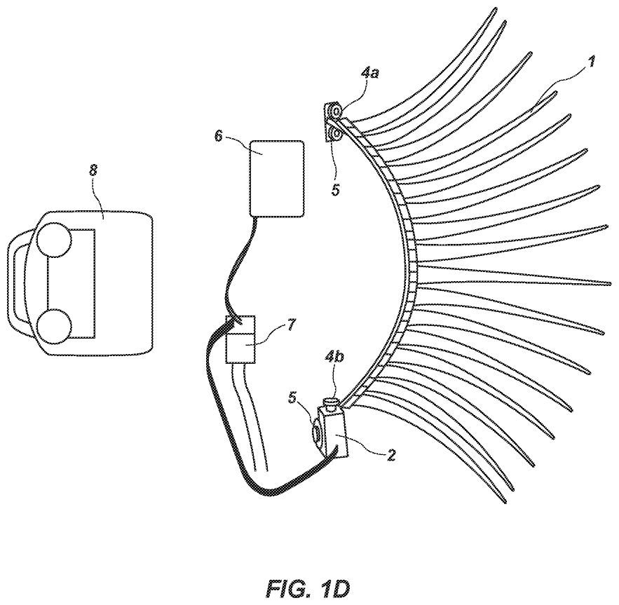

FIGS. 1a through 1c depicts a schematic diagram of one embodiment of an animated apparatus that is shaped like a pair of eyelashes. The eyelashes can be attached to a vehicle by attachment mounts 5. The attachment mounts 5 can be removable attached to the vehicle body using conventional techniques such as adhesive or fasteners. Control commands are sent from the remote control transmitter 8, to the receiver 7. The receiver 7 controls actuators 2a and 2b to animate the eyelashes 1a and 1b. The eyelashes 1a and 1b rotate on rotary pivots 4a, 4b, 4c, and 4d so as to create the effect of an eye opening and closing. The actuators 2a and 2b can be powered by power supply 6.

FIG. 1b depicts a 3D illustration of the animated apparatus described in FIG. 1a showing one side of the apparatus shaped like an eyelash. Eyelash 1 is attached to a vehicle by attachment mounts 5. Control commands are sent from the remote control transmitter 8, to the receiver 7. The receiver 7 controls actuators 2a and 2b to animate the eyelashes 1a and 1b. The actuators can be rotary actuators cause the eyelashes 1 to rotate about rotary pivots 4a and 4b when actuated. The eyelash 1 rotates on rotary pivots 4a and 4b so as to create the effect of an eye opening and closing. The actuators 2a and 2b are powered by power supply 6.

FIG. 1c depicts four 3D illustrations of the animated apparatus described in FIG. 1 showing the eyelash 1 in up and down positions. The first illustration (top left) shows the eyelash 1 in an up position which represents an eye that is open. The second illustration (top right) shows the eyelash 1 in a down position which represents an eye that is closed, for example after the eyelash 1 has rotated on rotary pivots 4a and 4b. The third illustration (bottom left) shows the eyelash 1 in an up position which represents an eye that is open again. The fourth illustration (bottom right) shows the eyelash 1 in a down position which represents an eye that is closed. Thus, as the eyelash 1 moves through the positions shown in FIG. 1c it appears as though an eye of the vehicle is winking.

FIG. 1d depicts a 3D illustration of the animated apparatus described in FIG. 1 showing the components of the apparatus including only one of two or more eyelashes 1. The animated apparatus can includes the eyelash 1, the actuator 2, the rotary mounts 4s, 4b, the attachment mounts 5, the power supply 6, the receiver 7, and the controller 8.

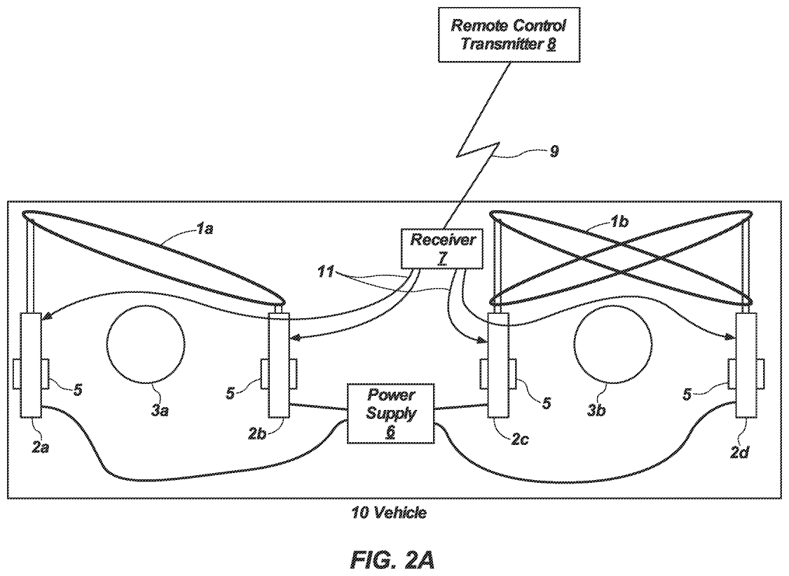

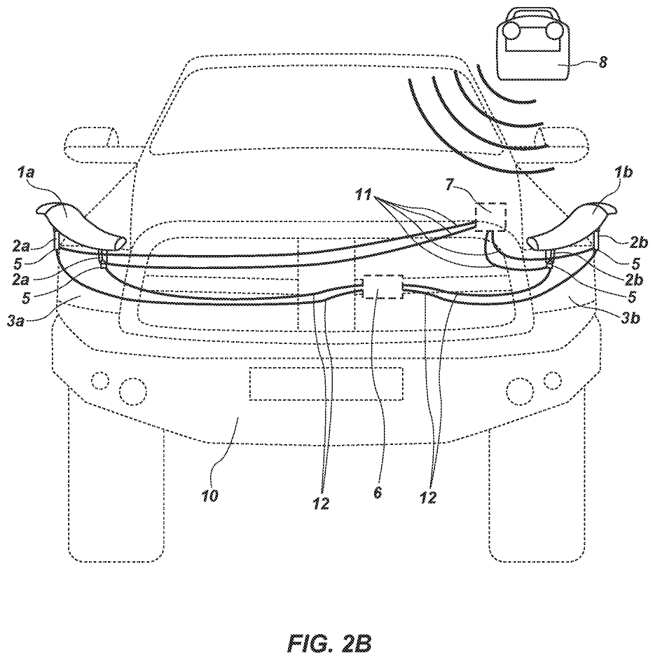

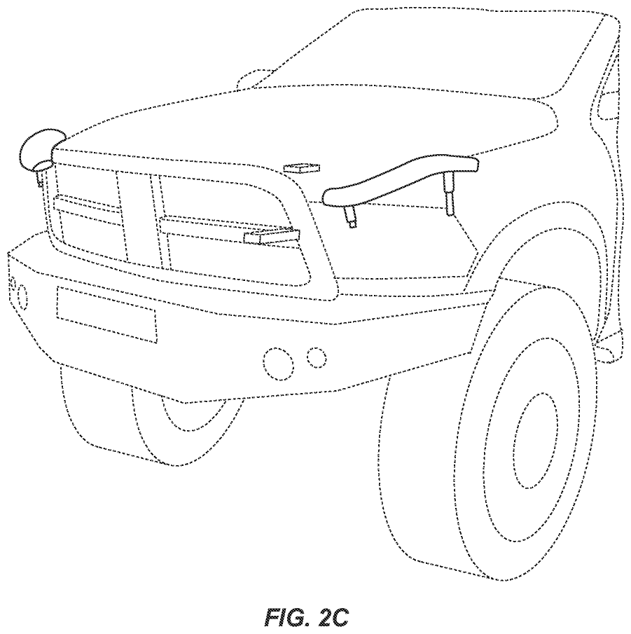

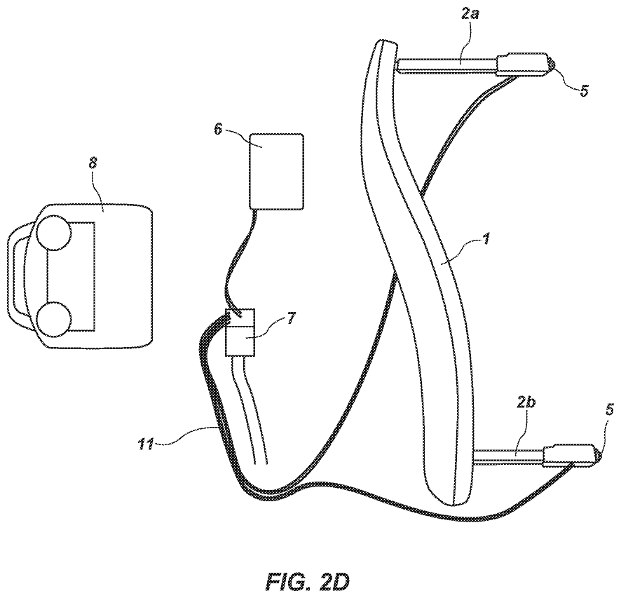

FIGS. 2a through 2d illustrate another example of an animated apparatus with large eyebrows 1a, 1b. Adding large eyebrows 1a, 1b above the headlights on a vehicle makes the headlights appear to be the eyes of the vehicle. When the eyebrows 1a, 1b are raised or lowered, the vehicle seems to be alive. The vehicle can look angry or surprised to people and other drivers.

FIG. 2a depicts a schematic diagram the animated apparatus that is shaped like a pair of eyebrows 1a, 1b. Eyebrows 1a and 1b are attached to a vehicle by attachment mounts 5. Control commands are sent from the remote control transmitter 8, to the receiver 7. The receiver 7 controls actuators 2a, 2b, 2c, and 2d to animate the eyebrows 1a and 1b. The eyebrows 1a and 1b are positioned by actuators 2a, 2b, 2c, and 2d to create the effect of various facial expressions such as surprise and anger. The actuators 2a and 2b are powered by power supply 6.

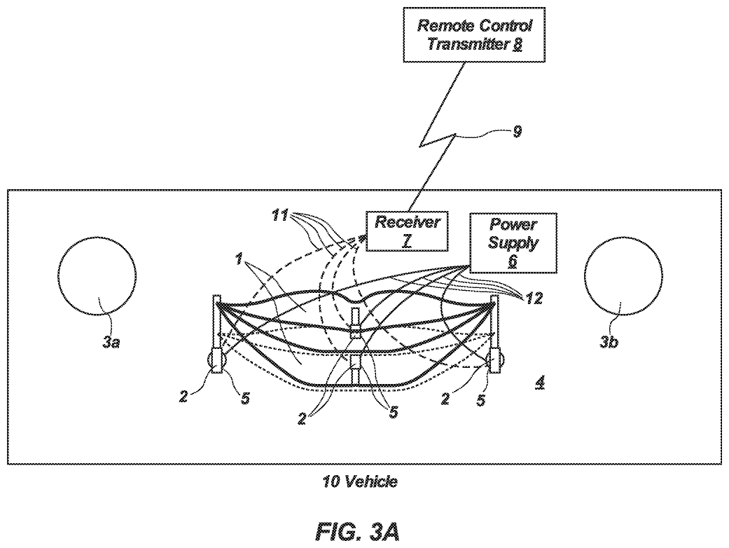

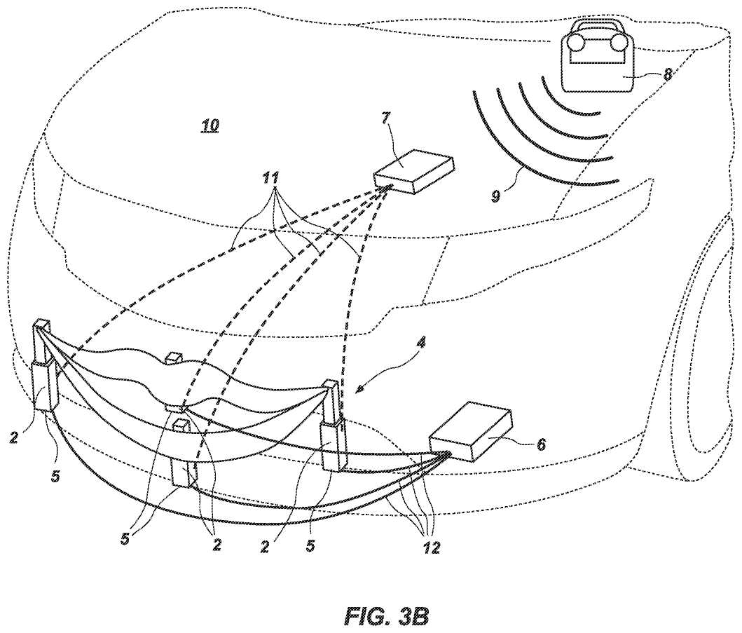

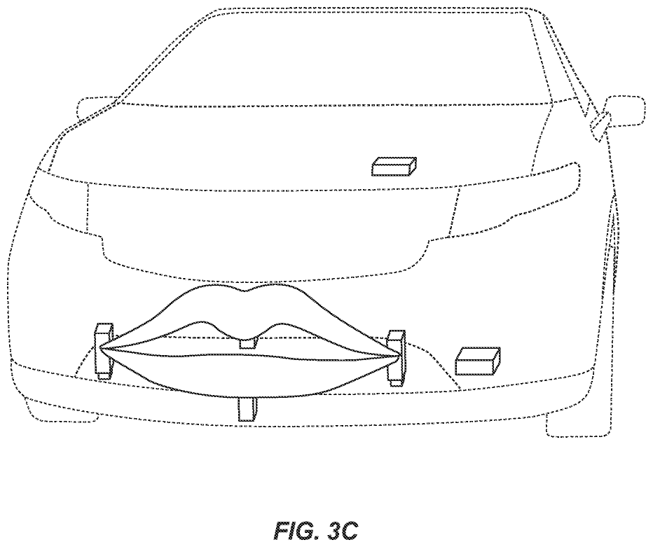

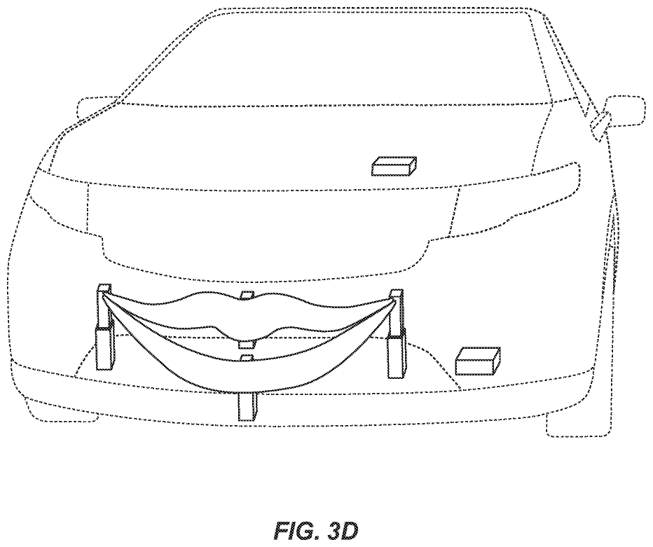

FIG. 2b depicts a 3D illustration of the animated apparatus described in FIG. 3 showing the apparatus shaped like eyebrows. Eyebrows 1a and 1b are attached to a vehicle by attachment mounts 5. Control commands are sent from the remote control transmitter 8, to the receiver 7. The receiver 7 can be attached to the vehicle in any location which allows connection to the actuators 2a and 2b including inside the vehicle hood and engine compartment. The receiver 7 controls actuators 2a and 2b to animate the eyebrows 1a and 1b. The eyebrows 1a and 1b are positioned by actuators 2a, 2b, 2c, and 2d to create the effect of various facial expressions such as surprise and anger. The actuators 2a and 2b are powered by power supply 6.

FIG. 2c depicts a 3D illustration of the animated apparatus described in FIG. 3 showing the apparatus shaped like eyebrows. In the example of FIG. 2c, the wiring and other components are hidden underneath the body of the vehicle such that only the eyebrows are visible.

FIG. 2d depicts a 3D illustration of the animated apparatus described in FIG. 1 showing the components of the apparatus including only one of two or more eyebrows. The actuators 2a and 2b can be linear actuator to effect the movement of the eyebrows as opposed to the rotary actuators of the embodiment of FIG. 1.

FIGS. 3a-3d illustrate another example of an animated apparatus using large lips. Adding large lips to the center area on the front of a vehicle makes the front of the vehicle look like a face. When the lips move the vehicle seems to be alive. The vehicle can look happy or sad or form a kiss for people and other drivers nearby.

FIG. 3a depicts a schematic diagram of an embodiment of the animated apparatus that is shaped like a mouth and lips. Lips 1 are attached to a vehicle by attachment mounts 5. Control commands are sent from the remote control transmitter 8, to the receiver 7. The receiver 7 controls actuators 2 to animate the lips 1. The actuators in this embodiment can be linear actuators. Four linear actuator may be used to control each end of the lips and the center location of each lip. The lips 1 are positioned by actuators 2 to create the effect of various facial expressions such as smiling, frowning, open mouth surprise, etc. The actuators 2 are powered by power supply 6. The actuators can be rotary and/or linear to allow for desired movements of the lips. The lips can be flexible so as to stretch and bend based on the positioning of the actuators.

FIG. 3b depicts a 3D illustration of the animated apparatus showing the apparatus shaped like mouth with lips. Lips 1 are attached to a vehicle by attachment mounts 5. Control commands are sent from the remote control transmitter 8, to the receiver 7. The receiver 7 can be attached to the vehicle in any location which allows connection to the actuators 2 including inside the vehicle hood and engine compartment. The receiver 7 controls actuators 2 to animate the lips 1. The lips 1 are positioned by actuators 2 to create the effect of various facial expressions such as smiling, frowning, open mouth surprise, etc. The actuators 2 are powered by power supply 6. The actuators can be rotary and/or linear to allow for desired movements of the lips. The lips can be flexible so as to stretch and bend based on the positioning of the actuators.

FIG. 3c depicts a 3D illustration of the animated apparatus described in FIG. 3 showing the apparatus shaped like a mouth with lips in a neutral expressions shape—the lips are not smiling or frowning. The lips actuators and lips may be removably mounted to an exterior surface of the vehicle and the remaining components may be hidden underneath the exterior surface as shown in FIG. 3c.

FIG. 3d depicts a 3D illustration of the animated apparatus described in FIG. 1 showing the apparatus shaped like a mouth with lips with the actuators at the end of each lip in an extended position, raising the corners of the mouth. The raised corners of the mouth result in a smiling shape.

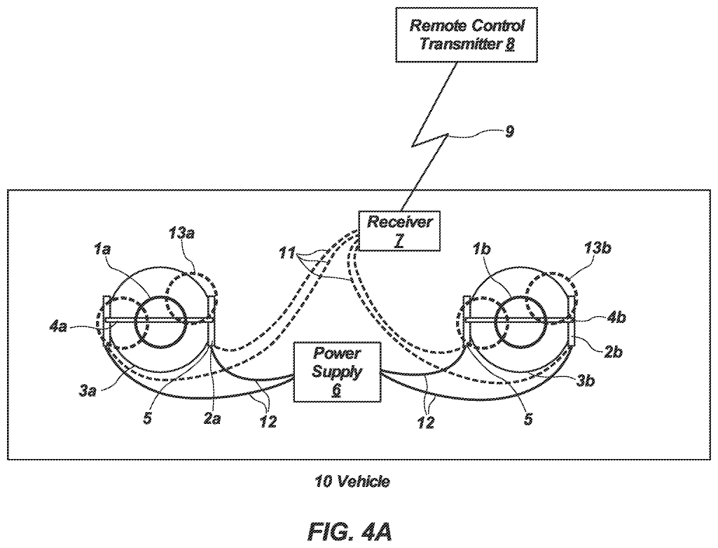

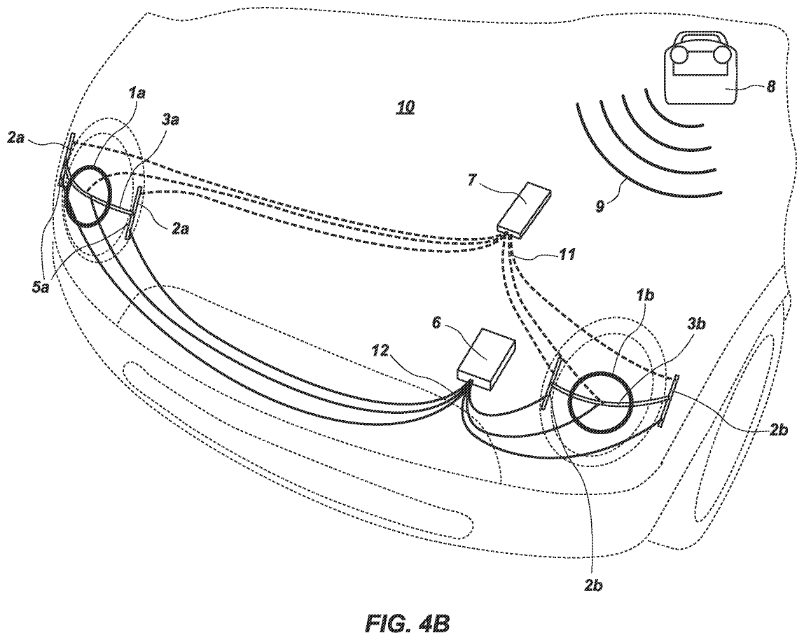

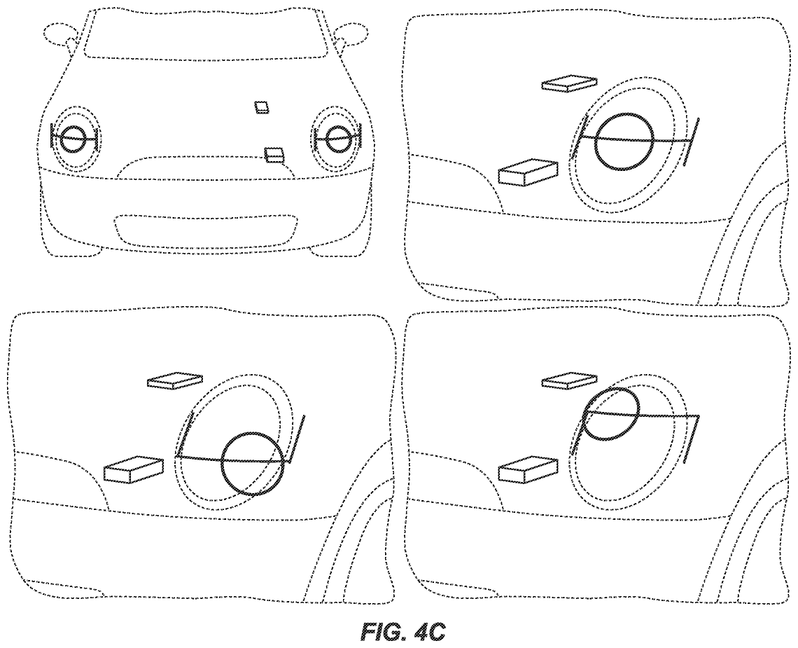

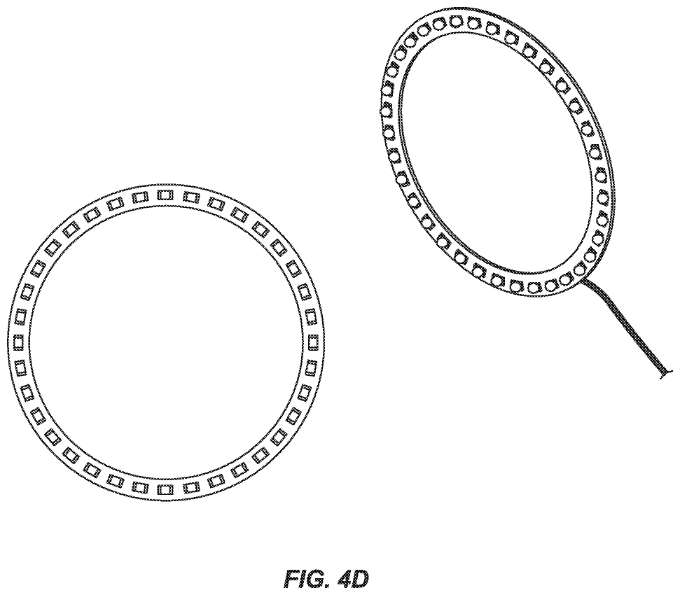

FIGS. 4a through 4d illustrate another example of an animated apparatus using large pupils on the front of vehicles headlights. Adding large pupils to the center area on the front of a vehicle's headlights makes the headlights look like eyes. The movement of the pupils can make the vehicle seem alive and express emotion. The vehicle can look left and right, up and down, and look at people and other drivers nearby depending on the location of the pupils. The pupils can be ring or disk shaped ovals which can be moved through a range encompassing a portion of the front of a headlight. The pupils can be physical objects or visual representations that use display elements such as a matrix or grid of LED lights attached to the surface of the headlight. If using a matrix of LED lights the iris could be represented by a ring image shaped from LEDs that are either on or off. If a higher fidelity matrix display is used the iris could be an image of an iris as on a jumbotron or television screen.

FIG. 4a depicts a schematic diagram of an embodiment of the animated apparatus that is shaped like the forward part of an eye encompassing the pupil and/or iris of the eye. Pupils 1a and 1b are affixed to a vehicle by attachment mounts 5a and 5b. Control commands are sent from the remote control transmitter 8, to the receiver 7. The receiver 7 controls actuators 2a and 2b to animate the pupils 1a and 1b. The pupils are positioned to create the effect of eyes looking in specific directions such as looking left, right, up, down, straight ahead, or cross-eyed. The actuators 2a and 2b are powered by power supply 6. The actuators can be rotary and/or linear to allow for desired movements of the pupils. The lips can be flexible so as to stretch and bend based on the positioning of the actuators. The actuators 2a and 2b are powered by power supply 6. The actuators can be rotary and/or linear and can include guide rails and or slides to allow for desired movements of the iris'. Each iris can be a complete or partial circular disk or ring shape to represent an iris. The shape can be open in the middle to allow for light from any headlight or light assembly to pass with minimal obstruction. The iris shape can have LED lights which help visually define the shape and can partially or completely replace any obstructed light fixture illumination.

FIG. 4b depicts a 3D illustration of the animated apparatus described in FIG. 7 showing the apparatus shaped like the forward part of an eye encompassing the pupil and/or iris of the eye. Pupils 1a and 1b are affixed to a vehicle by attachment mounts 5a and 5b. Control commands are sent from the remote control transmitter 8, to the receiver 7. The receiver 7 controls actuators 2a and 2b to animate the pupils 1a and 1b. The receiver 7 can be attached to the vehicle in any location which allows connection to the actuators 2a and 2b including inside the vehicle hood and engine compartment. The receiver 7 controls actuators 2a and 2b to animate the pupils 1a and 1b. The pupils 1a and 1b are positioned to create the effect of eyes looking in different directions such as looking left, right, up, down, or straight ahead. The pupils can be located in front of a vehicles headlights to enhance the effect of eyes or in other locations on the vehicle in order to create the effect of eyes. The actuators 2a and 2b are powered by power supply 6. The actuators can be rotary and/or linear and can include guide rails and/or slides 4a and 4b to allow for desired movements of the iris'. Each iris can be a complete or partial circular disk or ring shape to represent an iris. The shape can be open in the middle to allow for light from any headlight or light assembly to pass with minimal obstruction. The iris shape can have LED lights which help visually define the shape and can partially or completely replace any obstructed light fixture illumination. The iris shape can change in size via control from additional actuators to mimic the natural reaction of an iris to bright or dim light.

FIG. 4c depicts four 3D illustrations of the animated apparatus described in FIG. 1 showing the apparatus shaped like the forward part of an eye encompassing the pupil and/or iris of the eye. The first illustration (top left) shows the front of a vehicle with pupils in a neutral forward looking position. The second illustration (top right) shows a closer view of one headlight with the pupil in a neutral forward looking position. The third illustration (bottom left) shows a closer view of one headlight with the pupil positioned down and to one side to represent an eye looking down and to one side. The fourth illustration (bottom right) shows shows a closer view of one headlight with the pupil positioned up and to one side to represent an eye looking up and to one side.

FIG. 4d depicts a 3D illustration of the animated apparatus described in FIG. 1 showing one embodiment of the pupil component that is shaped like a ring with LED lights.

For one embodiment, the animated apparatus can represent a pair of eyes located against and inside a vehicles windshield or window so that the anatomical structure is visible from outside of the vehicle through the transparent windshield or window. This configuration allows the apparatus to be non-weather resistant as it is protected behind the vehicles window glass. This may also allow the apparatus to work better without the interference of wind and rain or snow. The eyes can be as simple as circles representing pupils that move up and down or left and right. The eyelids can be flat sheets that move up and down above the pupils. Alternately the eyes could be animations displayed on a flat panel LED or other display located against the inside of a vehicles window. This display could be partially transparent to allow a vehicles operator to see through the display.

The anatomical structure can represent some or all of a creature's facial features. The face provides perhaps the most important visual representation of a creature or person's mood and emotional state. Feelings of joy, happiness, anger, and surprise are easily understood by the animated movements and configurations of one or more of these elements of a face: eyes, eyelashes, eyelids, eyeballs, eyebrows, retina, iris, pupil, sclera, tears, nose, nostrils, forehead, jaw, mouth, lips, teeth, fangs, tongue, gums, throat, cheeks, facial muscles, beak, and snout.

In still another option, the anatomical structure can represent some or all of a creature's head structure. Turning, tilting, and nodding of the head provides useful visual information about a creature or person's state. Agreement, disagreement, inquisitiveness and other states can be indicated or enhanced by the animated movements and configurations of one or more of these elements of a head: ears, hair, mane, pony tail, horns, tusks, antlers, beak, trunk, muzzle, whiskers, and antenna.

Notably, in another option, the anatomical structure can represent any part of a creature's anatomy. The movement of almost any part of a creature provides visual information about the creature, the fact that it is alive, and what it is doing. For example, the rise and fall of a chest can indicate breathing. Flapping of wings can indicate an attempt to fly. Wagging a tail can indicate friendliness. The animated apparatus could represent one or more of these creature body parts: arms, hands, fingers, legs, thigh, calf, heel, knees, elbow, wrist, feet, heel, throat, chest, hip, toes, back, belly, rump, loin, udder, forearm, breast, neck, shoulder, wings, fins, claws, paw, hooves, comb, withers, finger nails, body segment, tail, scales, gills, feathers, fur, hair, skin, muscles (there are approximately 650 muscles in a human body), bones, vertebrae, armor plates, shell, membrane, thorax, abdomen, insect mouth parts, stinger, and compound eye.

In yet another alternative, the anatomical apparatus can mimic one or more of the muscles in the face. The facial muscles are a group of striated skeletal muscles supplied by the facial nerve (cranial nerve VII) that, among other things, control facial expression. These muscles are also called mimetic muscles. To represent a facial expression the apparatus would mimic the movement of some or all of these muscles. A muscle can be simulated with an actuator underneath an apparatus which represents the surface skin of a face. For example, with a cheek, the surface skin can be a rigid circular shape or part of a flexible surface that deforms when the actuator is activated. In the case of a deformable surface, the skin can represent some or all of a face with many actuators underneath that deform the surface to mimic the action of specific facial muscles and create the impression of a human or creature face.

For example, the anatomical apparatus can mimic one or more of the muscles used to smile: zygomaticus major and minor—pull up the corners of mouth, orbicularis oculi—causes the eye crinkle, levator labii superioris—pulls up the corner of lip and nose, levator anguli oris—helps to raise the angle of mouth, risorius—pulls the corners of mouth to the side of the face. Similarly, the anatomical apparatus can mimic one or more of the muscles used to frown: orbicularis oculi—causes the eye to crinkle, platysma—pulls down lips/mouth, wrinkles the skin on portions of the lower face, corrugator supercilii and procerus—furrows the brow, orbicularis oris—closes the mouth and puckers the lips, mentalis—causes a wrinkling of the chin. Known as the ‘pouting’ muscle, depressor anguli oris—pulls corner of mouth down.

In one example, the actuator can be of any suitable type for the intended vehicle and attachment location. Generally, a linear or rotary motor will drive the anatomical apparatus. Using off the shelf radio control or robotic motors work well. Hydraulic and or pneumatic actuators might be suitable for larger vehicle sizes or large apparatus shapes for more power or ease of installation. Rail guides are useful for movement along a path such as for a pupil following the curve of a headlight. Motion along the guide could be driven by an electric motor, hydraulic, or pneumatic actuator. Types of actuator could include, but are not limited to: electric motor, rotary servo motor, linear servo motor, hydraulic piston, pneumatic piston, cable and reel, pulley or pulley system, guide rail or track, comb drive, electroactive polymer, piezoelectric actuator, solenoid, stepper motor, shape-memory alloy, thermal bimorph, pendulum weight gravity orientation mechanism, and manually operated lever, cable, or gear linkage.

The animation of the apparatus can be managed by a controller in electronic or mechanical communication with the actuator. The controller responds to an input and sends signals to the actuator which animates the apparatus. The input to the controller can be the manipulation of buttons, dials, keys, knobs, levers, push buttons, selectors, or switches by an operator either onboard or not onboard the vehicle. In one configuration, a hand held box incorporating these elements can control the animated apparatus.

The animation of the apparatus can be managed by a controller in electronic or mechanical communication with the actuator. The controller responds to an input and sends signals to the actuator which animates the apparatus. The input to the controller can be the manipulation of buttons, dials, keys, knobs, levers, push buttons, selectors, or switches by an operator either onboard or not onboard the vehicle. In one configuration, a dashboard, or other location mounted box incorporating these elements can control the animated apparatus.

In one optional embodiment, the controller is connected to sensors to receive input based on user actions. Information about a user's movements, sounds, and actions can be detected and used to send control signals to the apparatus. Sensors can be optical, infrared, inductive, electromagnetic, mechanical, and acoustic. An optical sensor can include a motion sensor or a video camera which sends a signal to a microprocessor that runs facial and body movement analysis to send input to the controller. The sensors could detect one or more of: head movement, eye motion, mouth movement, arm movement, toe, foot, leg movement, body movement, hand finger movement, and voice command.

Alternatively, the animated apparatus can receive input to the controller from sensors triggered by one or more external events: people walking near vehicle, proximity of other vehicles, vehicle geographic location, remote input from mobile device app, time of day, vehicle speed, direction, or orientation, acoustic sounds or commands, vehicle occupant body movement, sun position, electric field orientation, magnetic field orientation, and pre-programmed timing signal.

In another option, the controller sends signals to the receiver which is attached to the animated apparatus. This signal can be transmitted via a wireless electromagnetic signal, a wired electric signal, mechanical link, on/off signal, variable signal from 0 to 100 percent of actuator motion range, multiple variable signals for multiple actuators. Generally, an operator will provide inputs to the controller which will send signals via one of these methods to the receiver which will activate the actuators. Wireless transmission allows the user to keep the controller in close proximity while remotely animating the apparatus.

In some cases, the animated apparatus can mimic the mood, feelings, and emotions of a living creature. When apparatus for eyes, eyebrows, and mouth are combined the shape of the mouth, angle of eyebrows and position of eyelids can mimic happiness, sadness, anger, fear, surprise and laughter.

Similarly, to convey the impression that a vehicle is really alive it is helpful to mimic specific creature behaviors or portions of sequences or action. Multiple apparatus can combine to mimic these behaviors which may involve emotion states such as aggression, fearfulness, or happiness. Example behaviors include, but are not limited to: crouching and growling, pawing ground, puffed up peacock feathers, cowering, eyes wide, eyes narrowed, eyes batting (fluttering), kissing, blowing a kiss, smacking lips, iris' expanding or contracting, arching back, rising up to look bigger, laughing, snorting, and huffing.

Since the power requirements of the automated apparatus may be substantial, it is advantageous to include a dedicated battery as the power supply. If the power requirements are small enough an existing battery onboard the vehicle can be used so long as it does not interfere with the power requirements of the vehicle. If the apparatus has a dedicated batter, it can be connected to one of the vehicles power supplies for charging and supplemental power. The dedicated batter could also be connected to solar panel or wind turbine charging circuits.

For vehicles that do not have headlights or other suitable lights that can represent eyes, the anatomical structure can mimic a whole eye including one or more of the following: eyeball, sclera, iris, pupil, eyelid, and eyelashes. This structure can be attached as one unit to any part of a vehicle. The eye structure can be animated to represent blinking, and looking in different directions. One embodiment would include the power supply, receiver, and solar cell charging all incorporated inside the volume of the eyeball shape. Two of these eyes could for example be attached to the prow of a boat with no external wiring connections required. Each eye can then be wirelessly controlled remotely. The eyes could also include sensors allowing them to respond to the external environment and look at and follow nearby people, boats, and objects.

The animated apparatus can be attached to any surface inside or outside of a vehicle. For example, the eyelashes anatomical structure attached above each headlight, or the eye anatomical structure can be attached inside the windshield inside the vehicle.

On many vehicles, trim, reflectors, and emblems have been attached to vehicles with double-sided foam tape specifically designed to adhere to car body surfaces without damaging the surface. In one embodiment, the vehicle coupling mechanism is double sided adhesive tape and is temporary or removable without permanent damage to the vehicle. The double-sided tape can connect the animated apparatus bonding directly between the apparatus and a surface of the vehicle or can be used to bond portions of a mechanical snap-on, screw-on, clip-on, hook and loop, mushroom head, or other detachable coupling system.

For convenience, the vehicle coupling mechanism can include a mechanical snap-on, screw-on, clip-on, magnetic, hook and loop, mushroom head, or other detachable coupling system interface member so that the attachment is temporary or removable without permanent damage to the vehicle. The portion of the detachable coupling system mechanism attached to a surface of the vehicle can be attached with double sided tape so that this portion of the coupling interface can be temporary or removable without permanent damage to the vehicle. The ability to remove the apparatus allows for running a car through a carwash to avoid possible damage. It also allows change out of the anatomical structure to, for example, change the color of eyelashes or eyebrows.

In some cases, the vehicle coupling mechanism can include a portion which is installed at the vehicle manufacturing origin, dealership, or aftermarket re-styler and stays on the vehicle for the life of the vehicle unless removed by a dealership or qualified technician. This portion can be one side of a snap-on, screw-on, clip-on, magnetic, hook and loop, mushroom head, or other detachable coupling system. The automated apparatus can be irremovably attached to the vehicle side portion of the vehicle coupling mechanism.

The anatomical structure can optionally be coupled to the actuator with a permanent mechanical coupling such as rivets, screws, glue, and double-sided tape. If the nature of the anatomical structure makes removal and change out desirable, the anatomical structure can be attached to the actuator by a snap-on, screw-on, clip-on, magnetic, hook and loop, mushroom head, or other detachable coupling system.

In order to more tightly integrate with the styling of a vehicle, in one alternative, the anatomical structure can represent an eye that incorporates one or more lights. The animated apparatus being designed to replace an existing headlight such that the apparatus attaches in the space where the original headlight was mounted. The apparatus can incorporate the ability to point the directional beam left, right, up, and down, to simulate an eye looking in a particular direction. The apparatus can include eyelid and eyelash elements so the that the eye simulates winking, opening and closing.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. An animated apparatus for a vehicle, comprising:
an anatomical structure representing an anatomical feature;
a vehicle coupling mechanism configured to removably couple the anatomical structure to a vehicle without modification of a vehicle structure;
an actuator coupled to the anatomical structure and configured to move the anatomical structure relative to the vehicle coupling mechanism to move the anatomical feature;
a controller in electronic or mechanical communication with the actuator, wherein the controller is configured to respond to an input to perform a movement of the anatomical structure to move the anatomical feature; and
a power supply coupled to the actuator to supply power to the actuator.

2. The animated apparatus of claim 1, wherein the anatomical structure represents one or more of an eyelash, an eyebrow, a mouth, or a pupil of an eye.

3. The animated apparatus of claim 1, wherein the anatomical structure represents a pair of eyes and wherein the pair of eyes are configured to be located against and inside of a vehicle's windshield or window so that the anatomical structure is visible from outside the vehicle through the windshield or window.

4. The animated apparatus of claim 1, wherein the anatomical structure is at least one of an eye, eyelid, eyeball, retina, iris, sclera, tear, nose, nostril, forehead, jaw, lip, teeth, fang, tongue, gums, throat, cheek, facial muscle, beak, snout, ears, hair, mane, pony tail, horn, tusk, antlers, beak, trunk, muzzle, whisker, antenna, arm, hand, finger, leg, thigh, calve, heel, knee, elbow, wrist, feet, heel, throat, chest, hip, toes, back, belly, rump, loin, udder, forearm, breast, neck, shoulder, wing, fin, claw, paw, hoof, comb, wither, finger nail, body segment, tail, scale, gill, feathers, fur, hair, skin, muscle, bone, vertebrae, armor plate, shell, membrane, thorax, abdomen, insect mouth part, stinger, or compound eye.

5. The animated apparatus of claim 1, wherein movements of the anatomical structure combine to represent a creature's emotion including at least one of happy, sad, angry, fear, surprise, or laughter.

6. The animated apparatus of claim 1, wherein the actuator is at least one of an electric motor, rotary servo motor, linear servo motor, hydraulic piston, pneumatic piston, cable and reel, pulley or pulley system, guide rail or track, comb drive, electroactive polymer, piezoelectric actuator, solenoid, stepper motor, shape-memory alloy, thermal bimorph, pendulum weight gravity orientation mechanism, and manually operated lever, cable, or gear linkage.

7. The animated apparatus of claim 1, wherein the controller comprises a hand held device operated from at least one of on-board the vehicle or remotely from a location external to the vehicle.

8. The animated apparatus of claim 1, wherein the controller is configured to removably attach to a surface of a vehicle.

9. The animated apparatus of claim 1, wherein the controller has at least one sensor configured to receive input based on a user action including at least one of head movement, eye motion, mouth movement, arm movement, toe, foot, or leg movement, body movement, hand finger movement, or voice command.

10. The animated apparatus of claim 1, wherein the input to the controller is at least one of a voice command, an external event, people walking near vehicle, proximity of other vehicles, vehicle geographic location, remote input from mobile device app, time of day, vehicle speed, direction, or orientation, acoustic sounds or commands, vehicle occupant body movement, sun position, electric field orientation, magnetic field orientation, or pre-programmed timing signal.

11. The animated apparatus of claim 1, wherein the input to the controller is at least one of a wireless electromagnetic signal, wired electric signal, mechanical link, on/off signal, variable signal, or multiple variable signals for multiple actuators.

12. The animated apparatus of claim 1, wherein movements of the anatomical structure combine to mimic specific creature actions including at least one of crouching, growling, pawing the ground, puffing up feathers, cowering, widening eyes, narrowing eyes, batting eyes, fluttering eyes, kissing, blowing a kiss, smacking lips, expanding an iris, contracting an iris, arching a back, rising up to look bigger, laughing, snorting, or huffing.

13. The animated apparatus of claim 1, wherein the power supply is at least one of a dedicated battery and a vehicle power supply.

14. The animated apparatus of claim 1, wherein the power supply is a dedicated battery configured to connect to a vehicle power supply for charging and supplemental power.

15. The animated apparatus of claim 1, wherein the power supply is a dedicated battery configured to couple a charging power including at least one of a solar panel or wind turbine.

16. The animated apparatus of claim 1, wherein the vehicle coupling mechanism is configured to secure the anatomical structure to an exterior or interior of the vehicle.

17. The animated apparatus of claim 1, wherein the vehicle coupling mechanism comprises double sided adhesive tape.

18. The animated apparatus of claim 1, wherein the vehicle coupling mechanism comprises at least one of a mechanical snap-on, screw-on, clip-on, hook and loop fastener, zipper, or clamp.

19. A kit for accessorizing a vehicle, comprising:
an animated apparatus for vehicles, comprising:
an anatomical structure representing an anatomical feature;
a vehicle coupling mechanism configured to removably couple the anatomical structure to a vehicle;
an actuator coupled to the anatomical structure and configured to move the anatomical structure relative to the vehicle coupling mechanism to mimic a movement of the anatomical feature;
a controller in electronic or mechanical communication with the actuator, wherein the controller is configured to respond to an input to control the actuator to perform a movement of the anatomical structure to mimic the movement of the anatomical feature; and
a power supply coupled to the actuator to supply power to the actuator; and
an instruction manual comprising instructions detailing a procedure for attaching the animated apparatus to a vehicle.
